(19) United States
(12) Patent Application Publication
(10) Pub. No.: US 2026/0219175 A1
(43) Pub. Date: Jul. 30, 2026

(54) GAS DETECTOR, GAS DETECTION MODULE, GAS DETECTION DEVICE, AND GAS DETECTION METHOD

(71) Applicant: TOPOLOGIC INC., Tokyo (JP)

(72) Inventor: Arata TAKAHASHI, Tokyo (JP)

(21) Appl. No.: 19/140,260

(22) PCT Filed: Dec. 20, 2023
(86) PCT No.: PCT/JP2023/045762

§ 371 Date: Jun. 17, 2025

(30) Foreign Application Priority Data
Dec. 22, 2022 (JP) 2022-206097

(51) Int. Cl. G01N 21/3504

(52) U.S. Cl. CPC G01N 21/3504

(57) ABSTRACT

A gas detector is provided. The gas detector comprises: a thin-film type heat flow sensor provided in a position to receive electromagnetic waves irradiated with a prescribed intensity; and a detecting unit which, if a measured value from the heat flow sensor changes due to a change in the received intensity of the electromagnetic waves, detects an amount of gas in a space through which the electromagnetic waves pass, on the basis of the change in the measured value.

### CROSS REFERENCE TO RELATED APPLICATIONS

This application is a 371 U.S. National Phase of International Application No. PCT/JP2023/045762, filed on Dec. 20, 2023, which claims priority to Japanese Patent Application No. 2022-206097, filed Dec. 22, 2022. The entire disclosures of the above applications are incorporated herein by reference.

### BACKGROUND

### Technical Field

This disclosure relates to a gas detector, gas detection module, gas detection device (apparatus), and gas detection method. BACKGROUND ART

### Related Art

Japanese Unexamined Patent Application Publication No. 2015-75384 discloses an infrared detector element including a pyroelectric substrate on which a slit shaped along the circumference of a first pyroelectric element is formed on a peripheral portion surrounding the first pyroelectric element so as to avoid first front surface wiring and first back surface wiring and a peripheral portion surrounding a second pyroelectric element is continuously formed over the entire circumference of a second portion.

A gas sensor using a pyroelectric sensor (a sensor that detects a specific gas) is low in response speed due to the large heat capacity of the pyroelectric sensor and has difficulty in, for example, in a space where the amount of a gas to be detected varies greatly, correctly capturing the inflow or outflow of the gas or instantaneously capturing the amount of the gas.

In view of the above circumstances, the present invention provides a gas detector and the like capable of detecting the amount of a gas in a short time.

### SUMMARY

One aspect of the present invention provides a gas detector. This gas detector includes a thin film-type heat flow sensor disposed in a position in which the heat flow sensor receives electromagnetic radiation emitted with a predetermined intensity and a detection unit configured to, when a change occurs in a measured value obtained by the heat flow sensor due to a change in the intensity of the electromagnetic radiation received, detect the amount of a gas in a space through which the electromagnetic radiation passes, on the basis of the change in the measured value.

Such an aspect allows for detection of the amount of the gas in a short time.

### BRIEF DESCRIPTION OF THE DRAWINGS

FIGS. 1A and 1B are diagrams showing an infrared gas sensor according to conventional art.

FIGS. 2A and 2B are diagrams showing another infrared gas sensor according to conventional art.

FIG. 3 is a diagram showing an example of the configuration of a gas detection device according to an embodiment.

FIGS. 4A and 4B are diagrams showing an infrared gas sensor according to an embodiment.

FIG. 5 is a diagram showing an infrared gas sensor according to a modification.

FIG. 6 is a diagram showing an infrared gas sensor according to another modification.

FIG. 7 is a diagram showing an infrared gas sensor according to another modification.

FIG. 8 is a diagram showing an infrared gas sensor according to another modification.

FIG. 9 is a diagram showing a gas detection device according to another modification.

FIG. 10 is a diagram showing an infrared gas sensor according to another modification.

FIG. 11 is a diagram showing an infrared gas sensor according to another modification.

FIGS. 12A and 12B are diagrams showing an infrared gas sensor according to another modification.

FIG. 13 is a diagram showing a gas detection module according to a modification.

### DETAILED DESCRIPTION

Now, a preferred embodiment of the present disclosure will be described in detail with reference to the accompanying drawings. In the present specification and drawings, components having substantially the same functional configuration are given the same reference signs and will not repeatedly be described.

A program to implement software in the present embodiment may be provided as a computer-readable non-transitory storage medium, or may be provided by download from an external server. The program may also be provided such that it is run on an external computer and its functions are implemented on a client terminal (so-called cloud computing).

The term “unit” in the present embodiment includes, for example, a combination of hardware resources implemented by a circuit in a broad sense and software information processing that can be specifically implemented by the hardware resources. Various types of information handled in the present embodiment are represented by, for example, the physical values of signal values representing voltages or currents, high or low signal values as binary bit sets consisting of 0s or 1s, or quantum superpositions (so-called qubits) and can be communicated and subjected to a calculation on a circuit in a broad sense.

The term “circuit in a broad sense” refers to a circuit implemented by combining at least a circuit, circuitry, a processor, memory, and the like appropriately. Specifically, the term “circuit in a broad sense” includes an application-specific integrated circuit (ASIC), programmable logic devices (e.g., a simple programmable logic device (SPLD), a complex programmable logic device (CPLD), a field programmable gate array (FPGA)), and the like.

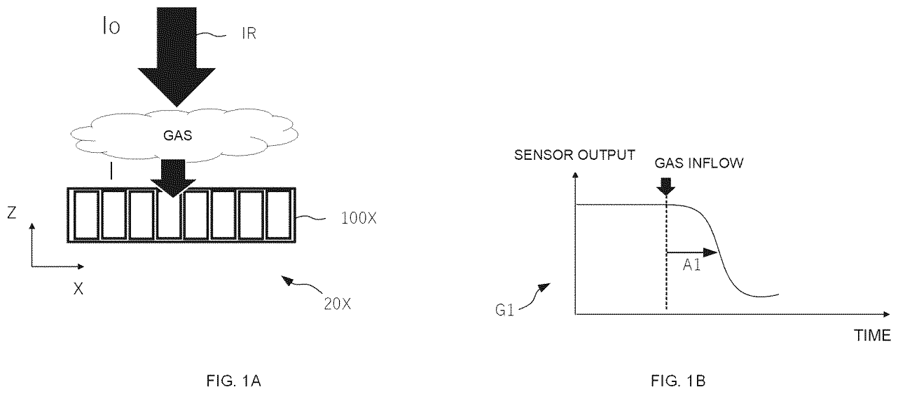

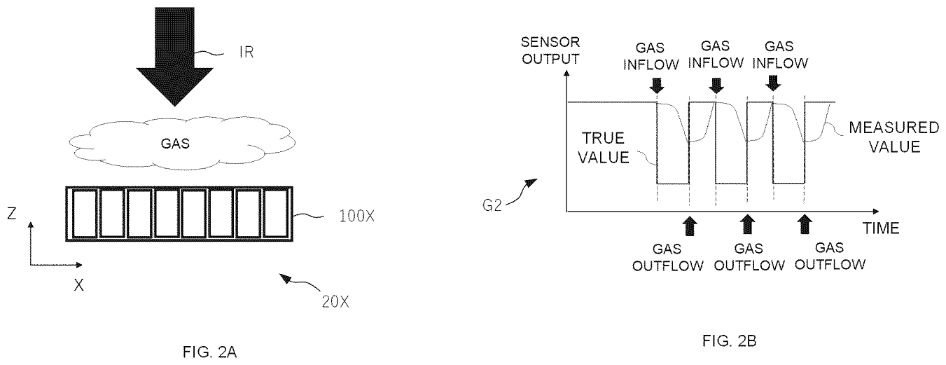

FIGS. 1A and 1B are diagrams showing an infrared gas sensor according to conventional art. FIGS. 2A and 2B are diagrams showing another infrared gas sensor according to conventional art. Conventional infrared gas sensors use a pyroelectric sensor and therefore are low in response speed and have difficulty in making correct measurements in a gas space in which a danger is predicted or the amount of gas varies greatly. For example, the infrared gas sensors 20X according to conventional art shown in FIGS. 1A and 2A determine the amount of a gas (e.g., CO2) by checking the absorption of infrared IR by the gas.

Specifically, the amount of the gas is determined using the following Formula 1.

$$- log ( l / lo ] = k \times c \times L \qquad Formula 1$$

where l and lo represent the intensity of light, k represents a constant, c represents the concentration of the gas, and L represents the length of an optical path.

These gas sensors use a pyroelectric sensor 100X, which has a large heat capacity and whose temperature does not easily rise. Therefore, the gas sensors are low in response speed (responsiveness). For this reason, these gas sensors have difficulty in, for example, in a space containing a gas whose amount varies greatly, correctly or instantaneously capturing the inflow or outflow of the gas and are not suitable for detecting an abnormality such as the leakage or explosion of the gas.

In a graph G1 shown in FIG. 1B, the vertical axis represents the sensor output (the output of the pyroelectric sensor 100X), and the horizontal axis represents the time. The sensor output is constant until the gas flows in and begins to fall when the gas flows in. However, due to the poor responsiveness of the pyroelectric sensor, the sensor output does not fall immediately but falls with a delay, as shown by an arrow A1.

In a graph G2 shown in FIG. 2B, the vertical axis represents the sensor output (the output of the pyroelectric sensor 100X), and the horizontal axis represents the time. The graph G2 shows the timings of inflow and outflow of a gas repeated in a short time and the true value of the sensor output representing the amount of the gas. The true value of the sensor output immediately falls when the gas flows in and immediately returns to the original amount when the gas flows out. On the other hand, the measured value outputted from the pyroelectric sensor falls with a delay even when the gas flows in. Thus, before the measured value completely falls, the gas flows out and the measured value turns upward. When the measured value of the sensor output completely rises to the value before the fall, the gas flows in and the measured value turns downward. In this way, due to the poor responsiveness of the pyroelectric sensor, the sensor output does not completely fall but repeatedly rises and falls around the value before the inflow of the gas.

For this reason, a thin film-type heat flow sensor element having a small heat capacity and using the anomalous Nernst effect is used in such a gas sensor. Thus, the speed at which light such as infrared is converted to heat and captured is increased. A gas sensor using such a thin film-type heat flow sensor element is able to, even in a space containing a gas whose amount varies greatly, capture the inflow and outflow of the gas correctly and instantaneously. Such a gas sensor can be used for purposes such as detection of an abnormality such as the leakage or explosion of a gas. Next, embodiments of the present disclosure will be described.

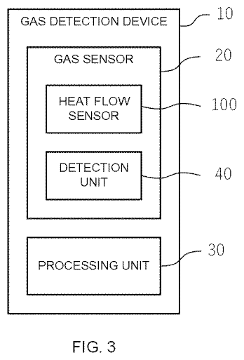

FIG. 3 is a diagram showing an example of the configuration of a gas detection device according to an embodiment. FIG. 3 shows a gas detection device 10 including a gas sensor 20 and a processing unit 30. The gas detection device 10 is an apparatus that detects the amount of a predetermined type of gas present in the surrounding space (hereafter referred to as the “detection space”) and performs processing in accordance with the detected amount of the gas. The gas here is carbon dioxide, carbon monoxide, city gas, liquefied petroleum (LP) gas, or the like and is a gas to be detected. When the “gas” is simply mentioned below, it refers to the gas to be detected.

The gas sensor 20 is a gas detector that detects the amount of the gas in the detection space. Hereafter, an example in which the gas sensor 20 detects the amount of carbon dioxide will be described. The gas sensor 20 includes a heat flow sensor 100 and a detection unit 40. The heat flow sensor 100 is a sensor that detects the amount of heat energy transferred. Heat flow sensors generally detect the amount of heat energy transferred (heat flux) per unit area and thus are also called heat flux sensors.

The processing unit 30 and the detection unit 40 are circuits that operate as computers for performing predetermined information processing. For example, the detection unit 40 detects the amount of the gas in the detection space on the basis of the amount of heat energy transferred measured by the heat flow sensor 100. The detection unit 40 supplies gas amount data indicating the detected amount of the gas to the processing unit 30.

When the gas sensor 20 detects the amount of the predetermined type of gas, the processing unit 30 performs a process in accordance with the amount of the gas (hereafter referred to as the “detection-time process”. For example, the processing unit 30 includes a speaker and, when the amount of carbon dioxide equal to or greater than a threshold is detected, performs an alarm sound raising process as the detection-time process. In this case, the processing unit 30 may change the volume of the alarm sound in accordance with the detected amount of the gas (may increase the volume of the alarm as the amount of the gas is increased).

In addition, for example, the processing unit 30 may include a communication unit and perform a process of sending an alarm to a registered destination as the detection-time process, or may include a display and perform a process of displaying information on the detected gas on the display as the detection-time process. The processing unit 30 may include storage means and store the detected amount of the gas in the storage means along with time information.

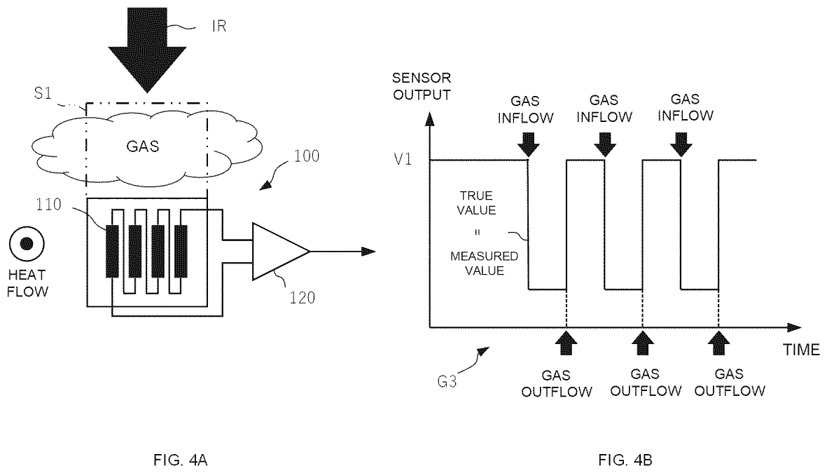

FIGS. 4A and 4B are diagrams showing an infrared gas sensor according to an embodiment. Note that the size and shape of members shown in FIG. 4A and later drawings are schematic and the actual size and shape are not limited to those shown. An infrared gas sensor 20 shown in FIG. 4A includes a heat flow sensor 100 and has a detection space S1 in which the gas and electromagnetic radiation (e.g. infrared IR) can circulate over the heat flow sensor 100. The heat flow sensor 100 is not a sensor having a large heat capacity like a pyroelectric sensor but is a thin film-type heat flow sensor.

The heat flow sensor 100 may be made of any material, such as a topological material (topological ferromagnetic material, topological antiferromagnetic material) called Weil semimetal, a ferrimagnetic material, or a Heusler alloy as long as the material is able to perform sensing through thermoelectric conversion based on the anomalous Nernst effect. The heat flow sensor 100 has a much lower heat capacity than Seebeck-type heat flow sensors and is therefore very responsive when heat flows in or out. Thus, the “measured value” obtained by sensing and the “true value” based on the gas concentration approximately match each other.

The heat flow sensor 100 includes a thermoelectric conversion unit 110 and an amplifier 120. The thermoelectric conversion unit 110 is an element that performs thermoelectric conversion. The thermoelectric conversion unit 110 outputs a signal generated on the basis of the transfer of heat energy (hereafter referred to as the “heat flow sensor signal”) to the amplifier 120. The intensity of the heat flow sensor signal is represented by the following Formula 2.

k*M*Q Formula 2
where k represents a constant, M represents the magnetization of the heat flow sensor, and Q represents a heat flow.

The amplifier 120 is a circuit that amplifies a current generated through thermoelectric conversion by the thermoelectric conversion unit 110. The amplifier 120 outputs the amplified heat flow sensor signal to the detection unit 40 shown in FIG. 3. When the gas flows into the detection space S1, electromagnetic radiation (e.g., infrared IR) is absorbed or reflected by the inflow gas and thus only a part of the electromagnetic radiation reaches the thermoelectric conversion unit 110. When the amount of the gas becomes larger, the amount of electromagnetic radiation that reaches the thermoelectric conversion unit 110 becomes smaller, that is, the intensity of the heat flow sensor signal becomes lower. For example, the detection unit 40 stores the relationship between the intensity of the heat flow sensor signal and the amount of the gas in advance and detects the amount of the gas on the basis of the heat flow sensor signal outputted.

FIG. 4B shows a graph G3 in which the vertical axis represents the sensor output of the heat flow sensor 100 (the voltage of the heat flow sensor signal outputted by the amplifier 120) and the horizontal axis represents the time. When the gas is not present in the detection space S1, the sensor output is a constant value V1. This means that when detecting the amount of the gas using the heat flow sensor 100, the heat flow sensor 100 is disposed in a position in which it receives electromagnetic radiation emitted with a predetermined intensity (in the example in FIG. 4B, an intensity that makes the sensor output the value V1) (for example, in a room where the intensity of infrared IR emitted from a light source is constant and unchanging).

When the gas flows into the detection space S1, the electromagnetic radiation is blocked by the gas. Thus, the amount of the electromagnetic radiation that reaches the thermoelectric conversion unit 110 is reduced, resulting in a reduction in the sensor output. When the gas flows out of the detection space S1, the electromagnetic radiation is no longer blocked by the gas. Thus, the amount of the electromagnetic radiation that reaches the thermoelectric conversion unit 110 returns to its original amount, resulting in return of the sensor output to its original value V1.

As seen above, the gas sensor 20 includes the thin film-type heat flow sensor 100 disposed in the position in which it receives electromagnetic radiation emitted with the predetermined intensity and the detection unit 40 that when a change occurs in the measured value obtained by the heat flow sensor 100 due to a change in the intensity of the electromagnetic radiation received, detects the amount of the gas in the space through which the electromagnetic radiation passes (the detection space S1), on the basis of the change in the measured value. In an example in FIG. 4, a light source such as a lamp is provided separately from the gas detection device 10, and the gas detection device 10 detects the amount of the gas using the electromagnetic radiation (infrared IR or the like) with the predetermined intensity emitted by the light source.

As shown in the graph of FIG. 4B, the output of the gas sensor 20 immediately falls when the gas flows into the detection space S1 and immediately returns to its original value V1 when the gas flows out of the detection space S1. On the other hand, in the case of the gas sensor using the pyroelectric sensor shown in FIG. 2B, even when the gas flows in, the gas flows out before the true value is outputted, resulting in failure in detection of the exact amount of the gas. Use of the heat flow sensor 100 allows for detection of the amount of the gas in a shorter time than when using such a pyroelectric sensor and allows for detection of the amount of the gas closer to the true value.

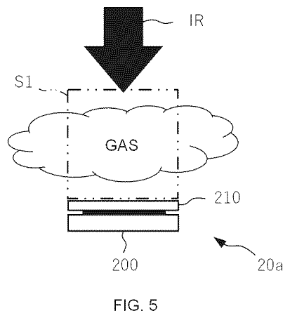

Next, a modification of the present embodiment will be described. FIG. 5 is a diagram showing an infrared gas sensor according to a modification. A heat flow sensor 200 shown in FIG. 5 is provided with an electromagnetic absorption film 210. By adjusting the absorption characteristics of electromagnetic radiation (e.g., infrared IR) with a wavelength range corresponding to the electromagnetic absorption film 210, sensitivity or selectivity can be improved.

More specifically, a gas sensor 20a includes the heat flow sensor 200 and the electromagnetic absorption film 210 that absorbs electromagnetic radiation with a predetermined wavelength. For example, when detecting the amount of electromagnetic radiation that absorbs infrared IR to a large extent, such as carbon dioxide, using the gas sensor 20a, the electromagnetic absorption film 210 is preferably that which absorbs electromagnetic radiation with the wavelength of infrared IR. However, this is not limiting. In the gas sensor 20a, the heat flow sensor 200 is disposed in a position reached by electromagnetic radiation that has passed through the electromagnetic absorption film 210.

Due to the disposition of the electromagnetic absorption film 210, even when a gas that absorbs electromagnetic radiation other than infrared IR to a large extent flows into the detection space S1, the amount of electromagnetic radiation that reaches the heat flow sensor 200 does not vary greatly and therefore almost no amount of such a gas is detected. In contract, when a gas that absorbs infrared IR to a large extent flows into the detection space S1, the amount of electromagnetic radiation that reaches the heat flow sensor 200 varies greatly and therefore the amount of such a gas is detected. In this way, according to an aspect shown in FIG. 5, the type of gas whose amount is to be detected is narrowed down.

Also, according to the aspect shown in FIG. 5, even when a gas that to a large extent absorbs electromagnetic radiation with a frequency different from that of electromagnetic radiation that the desired type of gas absorbs to a large extent flows into the detection space S1, it is less likely to mistakenly detect the amount of such a gas as the amount of the desired type of gas. The type of gas detected by the gas sensor 20a is not limited to carbon dioxide but may be any other type of gas such as carbon monoxide, city gas, or LP gas. In any case, by providing the electromagnetic absorption film 210 that absorbs electromagnetic radiation with frequencies other than that of electromagnetic radiation that the gas to be detected absorbs to a large extent, the type of gas whose amount is to be detected is narrowed down.

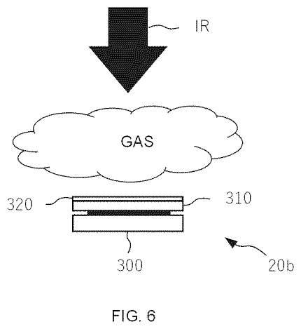

FIG. 6 is a diagram showing an infrared gas sensor according to another modification. In a heat flow sensor 100 shown in FIG. 6, a filter 320 is disposed on the upper side of an electromagnetic absorption film 310. This allows for selection among wavelengths.

More specifically, a gas sensor 20b shown in FIG. 6 includes a heat flow sensor 300, the electromagnetic absorption film 310, and the filter 320 that allows electromagnetic radiation with a predetermined wavelength to pass therethrough. For example, when detecting the amount of electromagnetic radiation that absorbs infrared IR to a large extent, such as carbon dioxide, using the gas sensor 20b, the electromagnetic absorption film 210 is preferably that which absorbs electromagnetic radiation with wavelengths other than that of infrared IR and the filter 320 is preferably that which allows electromagnetic radiation with the wavelength of infrared IR to pass therethrough and does not allow electromagnetic radiation with other wavelengths to pass therethrough. In the gas sensor 20b, the heat flow sensor 300 is disposed in a position reached by electromagnetic radiation that has passed through the filter 320.

Due to the disposition of the filter 320, even when a gas that absorbs electromagnetic radiation other than infrared IR to a large extent flows into the detection space S1, the amount of electromagnetic radiation that reaches the heat flow sensor 200 does not vary greatly and therefore almost no amount of such a gas is detected. In contrast, when a gas that absorbs infrared IR to a large extent flows into the detection space S1, the amount of electromagnetic radiation that reaches the heat flow sensor 200 varies greatly and therefore the amount of such a gas is detected. In this way, according to an aspect shown in FIG. 6, the type of gas whose amount is to be detected is narrowed down.

Also, according to the aspect shown in FIG. 6, even when a gas that to a large extent absorbs electromagnetic radiation with a frequency different from that of electromagnetic radiation that the desired type of gas absorbs to a large extent flows into the detection space S1, it is less likely to mistakenly detect the amount of such a gas as the amount of the desired type of gas. The type of gas detected by the gas sensor 20b is not limited to carbon dioxide but may be any other type of gas such as carbon monoxide, city gas, or LP gas. In any case, by providing the filter 320 that allows electromagnetic radiation with the frequency of electromagnetic radiation that the gas to be detected absorbs to a large extent to pass therethrough, the type of gas whose amount is to be detected is narrowed down.

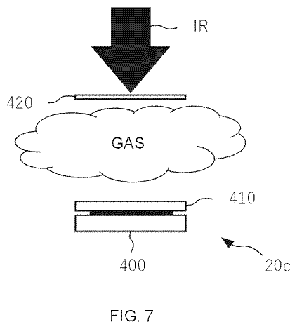

FIG. 7 is a diagram showing an infrared gas sensor according to another modification. In a heat flow sensor 400 shown in FIG. 7, a filter 420 is not disposed directly on the heat flow sensor but is disposed in a position opposite to the heat flow sensor 400 with a detection space S1 entered by a gas therebetween.

As in an example in FIG. 6, a gas sensor 20c shown in FIG. 7 includes the filter 420 that allows electromagnetic radiation with a predetermined wavelength (e.g., infrared IR) to pass therethrough and the heat flow sensor 400 disposed in a position reached by the electromagnetic radiation that has passed through the filter 420. In the gas sensor 20b shown in FIG. 6, the electromagnetic absorption film 310 is disposed to adhere to the heat flow sensor 100, and the filter 320 is disposed to adhere to the electromagnetic absorption film 310. On the other hand, in the gas sensor 20c, the electromagnetic absorption film 410 is disposed to adhere to the heat flow sensor 400, but the filter 420 is disposed at a distance from the electromagnetic absorption film 410.

In this case, the filter 420 may be provided, for example, as a part of a housing forming a gas flow path. Preferably, this housing does not transmit electromagnetic radiation except for its area in which the filter 420 is disposed. By disposing the heat flow sensor 400 in a position reached by electromagnetic radiation that has passed through the filter 420 and entered the housing, the filter 420, which is a part of the housing forming the gas flow path, serves as an electromagnetic radiation inlet, as well as narrows down the gas to be detected.

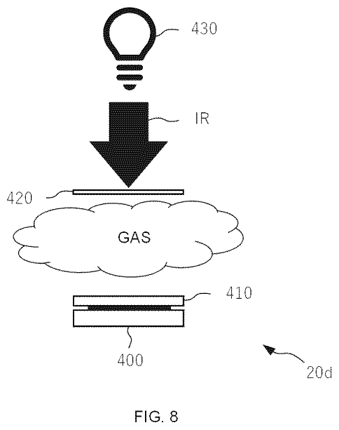

Another modification of the present embodiment will be described. FIG. 8 is a diagram showing an infrared gas sensor according to another modification. As shown in FIG. 8, electromagnetic radiation such as infrared IR may be provided with a light source 430 such as a lamp, LED, or laser.

A gas sensor 20d shown in FIG. 8 includes a heat flow sensor 400, an electromagnetic absorption film 410, a filter 420, and the light source 430. The light source 430 is an example of an emitter configured to emit electromagnetic radiation. For example, the light source 430 emits light including infrared IR as electromagnetic radiation. Such an aspect eliminates the need to provide an electromagnetic radiation emitter separately from the gas detection device 10 as described in the example in FIG. 4A.

In the gas sensor 20d, the light source 430 may emit electromagnetic radiation with a predetermined wavelength. In this case, the detection unit 40 may detect the amount of gas of a type corresponding to the wavelength of electromagnetic radiation emitted by the light source 430. Specifically, for example, the light source 430 may emit only infrared IR as electromagnetic radiation, and the detection unit 40 may detect carbon dioxide, which absorbs infrared IR to a large extent. Depending on the type of gas to be detected, the light source 430 may emit light other than infrared IR as electromagnetic radiation, or an emitter that emits electromagnetic radiation with a wavelength other than that of light may be provided. In any case, the amount of gas of the desired type can be detected.

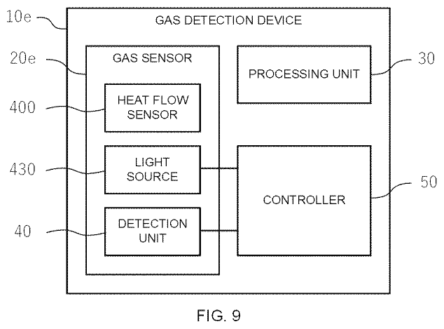

Another modification of the present embodiment will be described. FIG. 9 is a diagram showing a gas detection device according to another modification. As shown in FIG. 9, a light source 430 may be controlled such that the light source 430 is turned on only when making measurements. FIG. 9 shows a gas detection device 10e including the gas sensor 20e shown in FIG. 8, the processing unit 30 shown in FIG. 3, and a controller 50. The controller 50 is electrically connected to the light source 430, which is an example of an emitter, and controls the operation of the light source 430. In an example in FIG. 9, the controller 50 is also electrically connected to the detection unit 40 and also controls the operation of the detection unit 40.

For example, to reduce power consumption, the controller 50 causes the detection unit 40 to detect the amount of the gas periodically only for a predetermined period of time (e.g., only for 10 seconds per minute) rather than all the time. In this case, the controller 50 controls the light source 430 so that the light source 430 emits electromagnetic radiation (e.g., infrared IR) during a period when the detection unit 40 is detecting the amount of the gas. In other words, the controller 50 controls the light source 430 so that the light source 430 does not emit electromagnetic radiation during a period when the detection unit 40 is not detecting the amount of the gas. Such an aspect allows for a reduction in the energy consumption of the emitter (e.g., the light source 430).

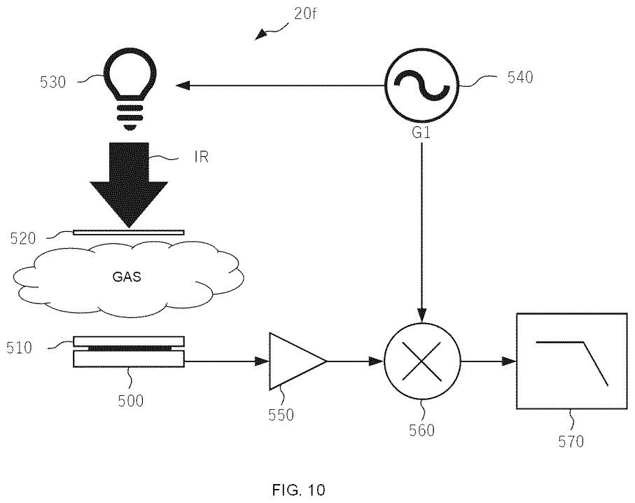

Another modification of the present embodiment will be described. FIG. 10 is a diagram showing an infrared gas sensor according to another modification. As shown in FIG. 10, a light source 430 modulates electromagnetic radiation to be emitted. Thus, noise can be reduced using heterodyne signal processing by a lock-in amplifier or the like. Such modulation may be performed by a mechanism that physically interrupts electromagnetic radiation or by electrical control. The signal processing may be performed by an analog circuit, a digital circuit, or both.

FIG. 10 shows a gas sensor 20f including a heat flow sensor 500, an electromagnetic absorption film 510, a filter 520, the light source 530, an oscillator 540, an amplifier 550, a mixer 560, and a low-pass filter 570. The light source 530 is a lamp, an LED, a laser, or the like and emits electromagnetic radiation such as infrared IR. The oscillator 540 is a device that generates and outputs a signal with periodicity (hereafter referred to as “reference signal”). For example, the oscillator 540 generates and outputs a sine wave, a square wave, or the like as a reference signal. The oscillator 540 outputs the generated reference signal to the light source 530 and mixer 560.

The light source 530 modulates electromagnetic radiation to be emitted in accordance with the reference signal outputted. For example, the light source 530 emits electromagnetic radiation having a frequency synchronized with that of the reference signal. The emitted electromagnetic radiation reaches the heat flow sensor 500 through the filter 520 and electromagnetic absorption film 510. When the intensity of electromagnetic radiation that reaches the heat flow sensor 500 varies due to the inflow or outflow of the gas into or out of the detection space S1, the heat flow sensor 500 outputs a heat flow sensor signal indicating a generated heat flow to the amplifier 550.

The amplifier 550 amplifies the outputted heat flow sensor signal and outputs the amplified heat flow sensor signal to the mixer 560. The mixer 560 generates a signal by multiplying the heat flow sensor signal (measurement signal) received from the amplifier 550 by the reference signal received from the oscillator 540 and outputs the signal to the low-pass filter 570. Of the components of this signal, only a signal having a frequency equal to that of the reference signal among various signals contained in the measurement signal becomes a direct-current signal and passes through the low-pass filter 570, and the other components are converted to AC signals having frequencies other than 0 Hz and are therefore removed by the low-pass filter 570.

The signal that has passed through the low-pass filter 570 indicates a value obtained by reducing noise from the measured value of the electromagnetic radiation emitted from the light source 530. The signal that has passed through the low-pass filter 570 is inputted to the detection unit 40. The detection unit 40 detects the amount of the gas in the detection space S1 on the basis of the inputted signal. In this way, in an example shown in FIG. 10, noise is reduced by the lock-in amplifier mechanism using heterodyne signal processing.

As seen above, the gas sensor 20f includes the oscillator 540 that is an example of a modulator and modulates electromagnetic radiation to reach the heat flow sensor 500. The detection unit 40 reduces noise from the measured value obtained by the heat flow sensor 500 on the basis of the characteristics of the modulated electromagnetic radiation (in the example in FIG. 10, the characteristics modulated on the basis of the reference signal) and detects the amount of the gas. Such an aspect improves the accuracy of the amount of the gas detected compared to when noise is not reduced from the electromagnetic radiation.

In the example in FIG. 10, the detection unit 40 reduces noise from the measured value in synchronization with the signal (reference signal) derived from the modulation performed by the modulation unit (the oscillator 540). Such an aspect allows for removal of noise with higher accuracy than when the reference signal is not used. The method for reducing noise is not limited to the above method using the lock-in amplifier mechanism. For example, methods such as a method using a high-pass filter or band-pass filter and correlated double sampling (CDS) may be used.

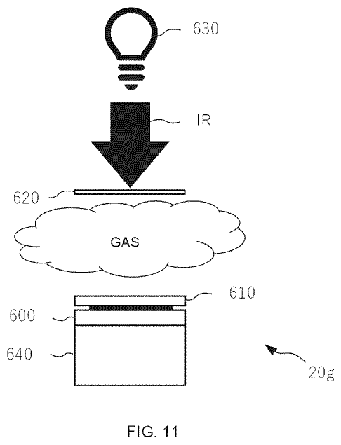

Another modification of the present embodiment will be described. FIG. 11 is a diagram showing an infrared gas sensor according to another modification. As shown in FIG. 11, a heat sink 640 may be disposed to avoid heat accumulation in a heat flow sensor 600.

FIG. 11 shows a gas sensor 20g including the heat flow sensor 600, an electromagnetic absorption film 610, a filter 620, a light source 630, and the heat sink 640. The light source 630 is a lamp, an LED, a laser, or the like and emits electromagnetic radiation such as infrared IR. The heat sink 640 is a device that receives heat generated by a heat generator such as the heat flow sensor 600 and dissipates the heat into the air. For example, the heat sink 640 is a largely undulating structure (fin) made of a material with high thermal conductivity (aluminum, copper, or the like) and therefore has high heat dissipation efficiency.

As seen above, the gas sensor 20g includes the heat sink 640 that is an example of a radiator and is disposed so as to contact the back side of the electromagnetic radiation receiving surface of the surfaces of the heat flow sensor 600. Such an aspect suppresses a reduction in the accuracy of the measured values due to heat accumulation (a situation where the temperature excessively rises due to heat accumulation) in the place where the gas sensor 20g is disposed, compared to when the gas sensor 20g does not include the heat sink 640.

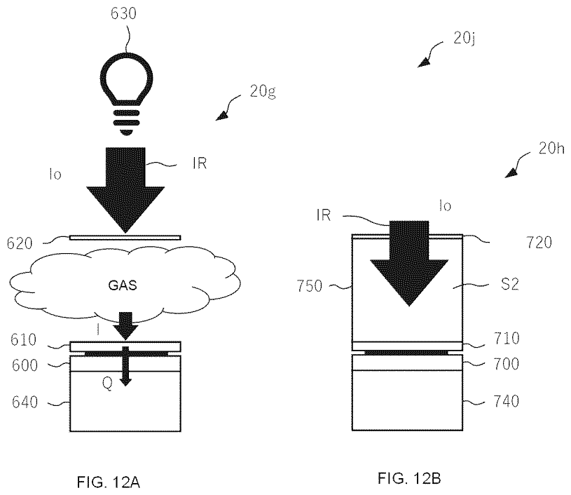

Another modification of the present embodiment will be described. FIGS. 12A and 12B are diagrams showing an infrared gas sensor according to another modification. As shown in FIG. 12B, a gas sensor 20h for directly measuring a light source may be disposed separately from the gas sensor 20g. Such a gas sensor 20h is preferably equivalent to the gas sensor 20g. Thus, even when the light source 630 deteriorates and the amount of infrared or the like varies, the absolute amount of the light source 630 is measured and thus the accuracy of gas measurement is maintained.

Specifically, FIGS. 12A and 12B show the gas sensor 20g shown in FIG. 11, as well as a gas sensor 20j including the gas sensor 20h. The gas sensor 20h includes a heat flow sensor 700, an electromagnetic absorption film 710, a filter 720, a heat sink 740, and a side plate 750. The side plate 750 is a plate member that surrounds a block space S2 sandwiched between the filter 720 and the electromagnetic absorption film 710. The side plate 750 blocks the flow of the gas between the block space S2 and the surrounding space, making the block space S2 a space that is not entered by the gas.

The gas sensor 20h is disposed in a position such that infrared IR, which is electromagnetic radiation emitted by the light source 630, enters the filter 720 and then reaches the heat flow sensor 700. The light source 630 emits infrared IR having an intensity of lo to the filter 620. Similarly, it emits infrared IR having an intensity of lo to the filter 720. As shown in FIG. 12A, the infrared IR that has entered the filter 620 is absorbed by the gas present ahead of the filter 620 and its intensity decreases to 1. On the other hand, as shown in FIG. 12B, the intensity of infrared IR that has entered the filter 720 is not reduced by the gas due to the gas not entering the block space S2.

The filter 720 may be configured such that infrared IR having an intensity that is several multiples of lo can enter the filter 720. In the gas sensor 20h, the block space S2 may be configured such that infrared IR directly hits the heat flow sensor 700. Specifically, the heat flow sensor 700 may be disposed in a direction different from the direction in which the heat flow sensor 600 is disposed when viewed from the light source 630 and so as to be close to the light source 630 to the extent that the effect of absorption of infrared IR by the gas is no longer seen. Thus, infrared IR from the light source 630 directly reaches the heat flow sensor 700, which then measures the infrared IR and outputs it as the sensor output serving as the reference of the light source 630. A half mirror may be disposed between an area including the light source 630 and heat flow sensor 600 and the block space S2 so that infrared IR emitted by the light source 630 passes through the half mirror and directly reaches the heat flow sensor 700.

As a result, the gas sensor 20j includes the heat flow sensor 700 that is an example of a thin film-type second heat flow sensor and is disposed in a position in which the heat flow sensor 700 receives electromagnetic radiation that has passed through the block space S2 into which the gas does not flow. When a change occurs in the measured value (first measured value) of a heat flow obtained by the heat flow sensor 700 (second heat flow sensor), the detection unit 40 detects the amount of the gas by reflecting the change on the measured value (second measured value) of the heat flow sensor 600 (first heat flow sensor).

For example, when the heat flow sensor 700 receives electromagnetic radiation from the light source 630, as well as electromagnetic radiation from another light source passing behind the light source 630, that is, when the heat flow sensor 700 receives electromagnetic radiation with a temporarily increased intensity, the first measured value is temporarily increased. For this reason, the detection unit 40 determines the amount of the gas by subtracting the temporarily increased value from the second measured value to remove the increase in the measured value based on the electromagnetic radiation from the other light source. This allows for more accurate measurement of the amount of the gas than when the change in the first measurement is not reflected.

When electromagnetic radiation emitted by the light source 630 is weakened due to deterioration of the light source 630, the first measured value is reduced. For this reason, the detection unit 40 measures the amount of the gas by adding the reduced value to the second measured value to compensate for the deterioration of the light source 630. It is assumed that the detection unit 40 stores the relationship between the intensity of the heat flow sensor signal and the amount of the gas in advance. In this case, when the second measured value is reduced due to deterioration of the light source 630, the detection unit 40 would detect a smaller amount of the gas, that is, a value smaller than the actual amount of the gas. For this reason, the detection unit 40 reflects the change in the first measured value on the second measured value as shown in FIG. 12A. This suppresses a reduction in accuracy due to deterioration of the electromagnetic radiation emission source compared to when this reflection is not made.

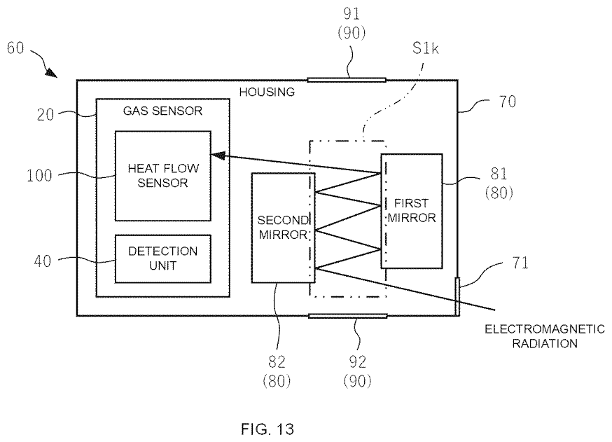

A modification of the present embodiment will be described. FIG. 13 is a diagram showing a gas detection module according to a modification. FIG. 13 shows a gas detection module 60. The gas detection module 60 is configured as a component detachable from a device that detects the amount of the gas and performs processing in accordance with the detection results, such as the gas detection device 10.

The gas detection module 60 includes the gas sensor 20, a housing 70 forming a detection space S1k through which electromagnetic radiation (e.g. infrared IR) passes, and a mirror 80 disposed inside the housing 70. The housing 70 has an opening 90 through which the gas flows into and out of the detection space S1 and an entrance window 71 through which electromagnetic radiation enters. The opening 90 includes a first opening 91 and a second opening 92 that allow the gas to easily pass through the detection space S1. The mirror 80 is positioned such that electromagnetic radiation that has entered through the entrance window 71 is repeatedly reflected by the mirror 80 until it is received by the heat flow sensor 100.

In an example in FIG. 13, the mirror 80 includes a first mirror 81 and a second mirror 82 disposed to face each other. The space sandwiched between the first mirror 81 and the second mirror 82 is the detection space S1k. When the gas to be detected is present in the detection space S1k, electromagnetic radiation passes through the gas over a longer distance than when the mirror 80 is not disposed and a larger amount of electromagnetic radiation than when the mirror 80 is not disposed is absorbed.

Such an aspect allows for detection of a smaller amount of the gas than when the mirror 80 is not disposed. Moreover, the use of the heat flow sensor 100 allows for detection of the amount of the gas in a shorter time than when a pyroelectric sensor is used.

The mirror 80 does not have to include the separated two mirrors. For example, one mirror may be formed in a cylindrical shape so that electromagnetic radiation is repeatedly reflected by the inner surface of the mirror. The mirror 80 may include three or more mirrors. The opening 90 may have only one opening or three or more openings. In short, it is only necessary that the gas circulate between the inside and outside of the housing 70.

While, in the above embodiments, infrared IR is used as an example of a light source, the light does not have to be of a particular type but may be any type of electromagnetic radiation, such as visible light, ultraviolet radiation, or X-rays. Also, the absorber does not have to be of a particular type. Preferably, the heat flow sensor is a thermoelectric conversion element that generates power on the basis of the anomalous Nernst effect. The heat flow sensor may be a thermoelectric conversion element that generates power on the basis of the spin Seebeck effect. In other words, the heat flow sensor preferably generates power in a direction perpendicular to the heat flow direction (i.e., in an in-plane direction of the sensor substrate). The substrate surface of the heat flow sensor may be a curved surface, a spherical surface, or the like. The heat flow sensor may have any size.

The gas sensors and sensor systems according to the embodiments may be implemented as software functions by various programs stored in hardware such as electronic circuits or elements (not shown) or may be implemented only as analog circuits (i.e., hardware). A gas detection method according to an embodiment may be performed by the above hardware.

A gas detection method according to an embodiment is a method including an acquisition step and a detection step performed by the detection unit 40 (an example of a computer) shown in FIG. 3 and the like.

Specifically, in the acquisition step, the detection unit 40 acquires the measurement results obtained by the thin film-type heat flow sensor (the heat flow sensor 100 or the like) disposed in the position in which it receives electromagnetic radiation emitted with a predetermined intensity.

In the detection step, when a change occurs in the measured value obtained by the heat flow sensor due to a change in the intensity of electromagnetic radiation received, the detection unit 40 detects the amount of the gas in the detection space S1 through which electromagnetic radiation passes, on the basis of the change in the measured value. Such a method according to the embodiment allows for detection of the amount of the gas in a shorter time than when a pyroelectric sensor is used.

Finally, while the various embodiments according to the present disclosure have been described above, the embodiments are only illustrative and are not intended to limit the scope of the invention. The novel embodiments can be carried out in other various forms, and various omissions, replacements, or changes can be made thereto without departing from the gist of the invention. The embodiments and modifications thereof are included in the scope and gist of the present invention, as well as included in the scope of the invention set forth in the claims and equivalents thereof.

### <Supplementary Notes>

The present disclosure may be provided in aspects below.

(1) A gas detector comprising: a thin film-type heat flow sensor disposed in a position in which the heat flow sensor receives electromagnetic radiation emitted with a predetermined intensity; and a detection unit configured to, when a change occurs in a measured value obtained by the heat flow sensor due to a change in the intensity of the electromagnetic radiation received, detect the amount of a gas in a space through which the electromagnetic radiation passes, on the basis of the change in the measured value.

Such an aspect allows for detection of the amount of the gas in a short time.

(2) The gas detector according to (1), further comprising an emitter configured to emit the electromagnetic radiation.

Such an aspect eliminates the need to prepare an electromagnetic radiation emitter.

(3) The gas detector according to (2), wherein: the emitter is configured to emit electromagnetic radiation with a predetermined wavelength, and the detection unit is configured to detect the amount of a gas of a type corresponding to the wavelength of the electromagnetic radiation.

Such an aspect allows for detection of the amount of a desired gas.

(4) The gas detector according to (2) or (3), further comprising a controller configured to control the emitter, the controller being configured to cause the emitter to emit electromagnetic radiation during a period when the detection unit detects the amount of the gas.

Such an aspect allows for a reduction in the energy consumption of the emitter.

(5) The gas detector according to any one of (1) to (4), further comprising a modulator configured to modulate electromagnetic radiation that is to reach the heat flow sensor, wherein the detection unit is configured to detect the amount of the gas by reducing noise from the measured value on the basis of characteristics of the modulated electromagnetic radiation.

Such an aspect allows for reduction of noise from the electromagnetic radiation.

(6) The gas detector according to (5), wherein the detection unit is configured to reduce noise from the measured value in synchronization with a signal originating from modulation performed by the modulator.

Such an aspect allows for elimination of noise with higher accuracy.

(7) The gas detector according to any one of (1) to (6), further comprising a filter configured to allow electromagnetic radiation with a predetermined wavelength to pass therethrough, wherein the heat flow sensor is disposed in a position reached by the electromagnetic radiation that has passed through the filter.

Such an aspect allows for detection of the amount of a gas of a desired type.

(8) The gas detector according to any one of (1) to (7), further comprising an absorption film configured to absorb electromagnetic radiation with a predetermined wavelength, wherein the heat flow sensor is disposed in a position reached by the electromagnetic radiation that has passed through the absorption film.

Such an aspect allows for detection of the amount of a gas of a desired type.

(9) The gas detector according to any one of (1) to (8), further comprising a heat sink disposed to be in contact with a back side of an electromagnetic radiation receiving surface of surfaces of the heat flow sensor.

Such an aspect suppresses a reduction in the accuracy of the measured value due to heat accumulation.

(10) The gas detector according to any one of (1) to (9), further comprising a thin film-type second heat flow sensor disposed in a position in which the second heat flow sensor receives electromagnetic radiation that has passed through a space into which the gas does not flow, wherein the detection unit is configured to, when a change occurs in a measured value by the second heat flow sensor, detect the amount of the gas by reflecting the change on the measured value of the heat flow sensor.

Such an aspect suppresses a reduction in accuracy due to deterioration of the electromagnetic radiation source.

(11) A gas detection module comprising: the gas detector according to any one of (1) to (10); a housing forming a space through which the electromagnetic radiation passes; and a mirror disposed in the housing, wherein: the housing has a first opening through which the gas flows into the space and a second opening through which the gas flows out, and the mirror is disposed to repeatedly reflect the electromagnetic radiation until the electromagnetic radiation is received by the heat flow sensor.

Such an aspect allows for detection of the amount of the gas in a short time.

(12) A gas detection apparatus comprising: the gas detector according to any one of (1) to (10); and a processing unit configured to, when the amount of a gas of a predetermined type is detected by the gas detector, perform processing in accordance with the amount of the gas.

Such an aspect allows for detection of the amount of the gas in a short time.

(13) A gas detection method executed by a computer, comprising: an acquisition step of acquiring a measured value obtained by a thin film-type heat flow sensor disposed in a position in which the heat flow sensor receives electromagnetic radiation emitted with a predetermined intensity; and a detection step of, when a change occurs in the measured value obtained by the heat flow sensor due to a change in the intensity of the electromagnetic radiation received, detecting, by the computer, the amount of a gas in a space through which the electromagnetic radiation passes, on the basis of the change in the measured value.

Such an aspect allows for detection of the amount of the gas in a short time. Of course, these aspects are not limiting.

Also, the embodiments and modifications described above may be arbitrarily combined and implemented.

Finally, while the various embodiments according to the present invention have been described above, the embodiments are only illustrative and are not intended to limit the scope of the invention. The above novel embodiments can be implemented in other various forms, and various omissions, replacements, or changes can be made thereto without departing from the gist of the invention. The embodiments and modifications thereof are included in the scope and gist of the present invention, as well as included in the scope of the invention set forth in the claims and equivalents thereof.

1. A gas detector comprising:
a thin film-type heat flow sensor disposed in a position in which the heat flow sensor receives electromagnetic radiation emitted with a predetermined intensity; and
a detection unit implemented by circuitry configured to, when a change occurs in a measured value obtained by the heat flow sensor due to a change in the intensity of the electromagnetic radiation received, detect the amount of a gas in a space through which the electromagnetic radiation passes, on the basis of the change in the measured value.

2. The gas detector according to claim 1, further comprising
an emitter configured to emit the electromagnetic radiation.

3. The gas detector according to claim 2, wherein:
the emitter is configured to emit electromagnetic radiation with a predetermined wavelength, and
the detection unit is configured to detect the amount of a gas of a type corresponding to the wavelength of the electromagnetic radiation.

4. The gas detector according to claim 2, further comprising
a controller implemented by circuitry configured to control the emitter, the controller being configured to cause the emitter to emit electromagnetic radiation during a period when the detection unit detects the amount of the gas.

5. The gas detector according to claim 1, further comprising
a modulator implemented by circuitry configured to modulate electromagnetic radiation that is to reach the heat flow sensor, wherein
the detection unit is configured to detect the amount of the gas by reducing noise from the measured value on the basis of characteristics of the modulated electromagnetic radiation.

6. The gas detector according to claim 5, wherein
the detection unit is configured to reduce noise from the measured value in synchronization with a signal originating from modulation performed by the modulator.

7. The gas detector according to claim 1, further comprising
a filter configured to allow electromagnetic radiation with a predetermined wavelength to pass therethrough, wherein
the heat flow sensor is disposed in a position reached by the electromagnetic radiation that has passed through the filter.

8. The gas detector according to claim 1, further comprising
an absorption film configured to absorb electromagnetic radiation with a predetermined wavelength, wherein
the heat flow sensor is disposed in a position reached by the electromagnetic radiation that has passed through the absorption film.

9. The gas detector according to claim 1, further comprising
a heat sink disposed to be in contact with a back side of an electromagnetic radiation receiving surface of surfaces of the heat flow sensor.

10. The gas detector according to claim 1, further comprising
a thin film-type second heat flow sensor disposed in a position in which the second heat flow sensor receives electromagnetic radiation that has passed through a space into which the gas does not flow, wherein
the detection unit is configured to, when a change occurs in a measured value by the second heat flow sensor, detect the amount of the gas by reflecting the change on the measured value of the heat flow sensor.

11. (canceled)

12. A gas detection apparatus comprising:
the gas detector according to claim 1; and
a processing unit implemented by circuitry configured to, when the amount of a gas of a predetermined type is detected by the gas detector, perform processing in accordance with the amount of the gas
a housing forming a space through which the electromagnetic radiation passes; and
a mirror disposed in the housing, wherein:
the housing has an opening through which the gas flows into and out of the space, and
the mirror is disposed to repeatedly reflect the electromagnetic radiation until the electromagnetic radiation is received by the heat flow sensor.

13. A gas detection method executed by a computer, comprising:
acquiring a measured value obtained by a thin film-type heat flow sensor disposed in a position in which the heat flow sensor receives electromagnetic radiation emitted with a predetermined intensity; and
when a change occurs in the measured value obtained by the heat flow sensor due to a change in the intensity of the electromagnetic radiation received, detecting the amount of a gas in a space through which the electromagnetic radiation passes, on the basis of the change in the measured value.
